(19) United States
(12) Patent Application Publication
(10) Pub. No.: US 2002/0191481 A1
(43) Pub. Date: Dec. 19, 2002

(54) Portable plant for mixing asphalt and rubber

(75) Inventors: Sidney Cox, Blanco, TX (US); Andrew Cox, Blanco, TX (US); Howard Cox, Blanco, TX (US); Randy Watt, Blanco, TX (US); Kel Lisenby, (US)

Correspondence Address: JACKSON WALKER, L.L.P., SUITE 2100, 112 EAST PECAN ST., SAN ANTONIO, TX, 78205, US

(73) Assignee: Cox Paving Company

(21) Appl. No.: 10/201,396

(22) Filed: Jul. 23, 2002

Related U.S. Application Data
(63) Continuation of application No. 09/633,378, filed on Aug. 7, 2000, now abandoned.

(51) Int. Cl. B28C 7/04; G05B 21/00

(52) U.S. Cl. 366/16; 366/8; 366/20; 700/265

(57) ABSTRACT

The present invention to provides for a novel asphalt mixing plant which is portable, that is, capable of being transported from one site to another. The portable asphalt mixing plant has a control system that adjusts the rate at which crumb rubber is added to oil so as to maintain a constant oil/rubber ratio in a mixer. The blending control process has a CPU to control the rate at which asphalt is pumped into a mixer and the rate at which crumb rubber is fed to the same mixer so as to maintain a constant asphalt rubber ratio in the produced asphalt. The main components of the portable asphalt mixing plant are located on a flatbed trailer and include the following: a hopper for storing loose crumb rubber; a crumb rubber delivery system for delivery of the crumb rubber from the hopper to the mixing chamber; a mixing chamber for the mixing therein; a delivery system for the delivery of asphalt (from a tank off the trailer) to the mixing chamber; a control system including motors, motor drives, a central processing unit, sensors, and computer program for the controlled delivery of crumb rubber and asphalt to the mixing chamber; a crumb rubber and asphalt mixing means including a motor and a onboard generator for powering the electrical elements of Applicant's system.

### BACKGROUND OF THE INVENTION

1 Field of the Invention

Applicant's invention relates to mixing asphalt and rubber, more particularly, to the automated mixing of asphalt and rubber on a transportable member.

2 Background Information

For several decades now asphalt and crumb rubber mixes have been used to pave roadways. Asphalt rubber roads have proven to exceed the life of ordinary asphalt roads and have other advantageous properties. Furthermore, the use of crumb rubber, as from ground up vehicle tires, helps rid the environment of an otherwise pernicious nuisance.

However, the mixing of hot asphalt and rubber has a number of problems not found with ordinary asphalt. One of these problems is that the percentages of asphalt to rubber must be consistent from batch to batch so that the resulting product has uniform physical properties. Furthermore, there must be a uniform wetting of the crumb rubber particles by the asphalt. Moreover, the asphalt rubber mix must be maintained within certain temperature limits.

Prior to Applicant's invention, the mixing of asphalt rubber was controlled manually through the use of hand operated hydraulic valves by an operator monitoring gauges. This required constant manual supervision of the system to insure proper asphalt rubber ratios.

Applicant's new system and method provides a unique assemblage of equipment and a unique control system mounted on a flatbed trailer for use as a self-contained automated mixing unit for taking hot asphalt, delivered to the trailer and mixing it with rubber from onboard crumb rubber storage system at a preselected ratio in an asphalt rubber mixer. The result is a consistent asphalt rubber blend to be used for applying to roadway services.

### SUMMARY OF THE INVENTION

It is an object of the present invention to provide for a novel asphalt and rubber mixing plant.

It is another object of the present invention to provide for a novel asphalt and rubber mixing plant which is portable, that is, capable of being transported from one site to another.

It is another object of the present invention to provide for a portable asphalt/rubber mixing plant with a control system that will adjust the rate at which rubber is added to asphalt so as to maintain a constant asphalt/rubber ratio in a mixer.

It is yet another object of the present invention to provide a blending control process having a CPU to control the rate at which asphalt is pumped into a mixer and the rate at which crumb rubber is fed to the same mixer so as to maintain a constant asphalt rubber ratio.

It is yet another object of the present invention to provide a blending control process having a computer program to control the rate at which rubber is pumped into a mixer and a rate at which crumb rubber is fed to the same mixer so as to maintain a constant asphalt/rubber ratio in the resulting asphalt.

The main components of Applicant's system are located on a flatbed trailer and include the following: a hopper for storing loose crumb rubber; a crumb rubber delivery system for delivery of the crumb rubber from the hopper to the mixing chamber; a mixing chamber for the mixing therein; a delivery system for the delivery of asphalt (from a tank off the trailer) to the mixing chamber; a control system including motors, motor drives, a central processing unit, sensors, and computer program for the controlled delivery of crumb rubber and asphalt to the mixing chamber; a crumb rubber and asphalt mixing means including a motor and a onboard generator for powering the electrical elements of Applicant's system.

### DESCRIPTION OF THE PREFERRED EMBODUMENTS

Applicant's equipment drawing, FIG. 1, illustrates the equipment used in Applicant's automated, portable asphalt rubber blending plant (10) to blend asphalt (virgin oil) cement (“asphalt”) and crumb rubber (“rubber”) to be used subsequently (“asphalt rubber mix”) for application to roadway surface. Applicant's asphalt blending plant (10) includes a flatbed or drop deck trailer (12) such a Dorsey™ drop deck trailer mounted on wheels to be pulled by a tractor (not shown). FIG. 1, also illustrates a hopper (14) for storage of crumb rubber (A) and the delivery of crumb rubber to a crumb rubber delivery system as forth in more detail below. Applicant's hopper (14) includes four (typically) hopper scales (14A), (14B) and (14D), each of the hopper scales in operative association with hopper support beams (14E), the hopper support beams (14E) (typically four) being mounted to the upper surface of the trailer as set forth in FIG. 1. The hopper scales will generate a signal proportional the weight of the crumb rubber in the hopper for use by a CPU to determine the amount of crumb rubber that has been removed from the hopper. At the lower end of the hopper there is a mouth (14F), which funnels loose, particulate crumb rubber into a rotary vane (16) which is powered by a rotary vane motor (18).

A mixing chamber (15), preferably a dual chambered mixing chamber is another major component mounted on the surface of trailer (12), for receipt of asphalt (oil) and the receipt of crumb rubber therein and for the mixing of these two elements therein, and, finally, for the delivery of the mix from the mixing chamber to an off site location.

The crumb rubber delivery system is discussed next.

The crumb rubber delivery system begins at the mouth of the hopper with rotary vane (16). The rotary vane has a cylinder with many slotted chambers for receipt of the crumb rubber from the hopper and for delivery of the crumb rubber, through rotation of the cylinder, to an auger (21) of a screw conveyor (20). When a chamber of the rotary vane rotates 180° it will dump the rubber onto the base of the screw conveyor.

At the base of the rotary vanes is a screw conveyor (20) having, therein a crumb rubber delivery screw or auger (21). The screw conveyor (20) is powered by a screw motor (22). The screw conveyor (20) delivers crumb rubber from the base of the rotary vane (16) to the top of the mixing chamber (15) where it falls, under gravity, into the mixing chamber (15) through a crumb rubber delivery chute (23).

The mixing chamber (15) includes a vertically mounted mixing auger (24) which is powered by a mixing auger motor (26). The mixing auger is located at the center of the mixing chamber (15) to mix the asphalt and crumb rubber.

Asphalt inlet (28) accepts asphalt (virgin oil) from an “off site” (that is, off trailer) asphalt source such as an asphalt delivery truck and, through the use of asphalt pump and motor (30) delivers hot asphalt to the mixing chamber (15) through asphalt delivery tube (31). In cooperation with (and typically upstream of) asphalt delivery tube (31) is mass flow meter (32), for continuously monitoring density, flow rate and temperature of the asphalt being delivered to the mixing chamber (15). The mass flow meter provides this data in signal form to the CPU.

Mixing chamber (15) typically includes an inner chamber (36) and an outer chamber (38) the two chambers typically concentric about the vertical axis of the shaft of the mixing auger. The inner chamber (36) contains the mixing auger and is separated from the outer chamber by a cylindrical wall. This construction may be characterized as a “cylinder within a cylinder” construction. An asphalt/rubber mix outflow tube (40) transports the mix from mixing chamber (15) to a pair of mix outlet ports (42A) and (42B), one on either side of the truck which are connected through the use of a mix cross tube (44). Upstream of mix cross tube (44) and downstream of both upper and lower mixing chamber outlet ports (45A) and (45B) of outflow tube (40) is mix discharge pump and motor (46) to control the discharge of the mix. This motor is connected to the CPU and may be operated from the control panel.

An air compressor storage tank (48) is kept under pressure by use of electrically powered compressor (50). Air tank (48) is connected by an air feed line (52) for delivery of compressed air to manifold (54), through which air is injected into the lower section of the hopper through jets to keep the crumb rubber from compacting.

A central processing unit (56) (including a panel and a display(58)) operates the motors and the system. Control panel display (58) is for controlling Applicant's plant (10). CPU (56) includes variable frequency drivers (57A) and (57B) for operating rotary valve motor (18) and asphalt pump motor (30). CPU (56) includes a housing with an air conditioning unit (59). A diesel generator (60), for example, a Komatsu 150 KVA “Whisper Watt” generator provides power to Applicant's plant and a 1,400 gallon diesel tank (62) is provided for fuel for the diesel generator and other auxiliary systems. Applicant's trailer may also come with forklift platform (64) for carrying a forklift (not shown) and a ladder or ladders (66).

EQUIPMENT TABLE

| Number | Description | Specifications and/or Source |
|---|---|---|
| 12 | Drop deck trailer | Dorsey Trailers, Elba, Alabama |
| 14A-D | Platform scales | Mettler Toledo, Columbus, Ohio |
| 16, 18 | Rotary vane and motor | Industrial Valves and Power, Inc., |
| | | Ocean Springs, Ms. |
| 20 | Screw conveyor | 12′ × 15′9″, 42° incline, Thomas |
| | | Conveyor Co., Fort Worth, Texas |
| 22 | Screw conveyor motor | Baldor 5 HP, 30A, 460 V |
| 24 | Mixing auger | Scott Turbon, Special Top Mount with |
| | | Bridge Turbon Mix, SN #425C TMIO- |
| | | WC-5B2 2.25X |
| 26 | Mixing auger motor | Baldor 30 HP 30A Motor, 4601 |
| 30 | Asphalt pumps and motor | |
| 32 | Mass flow meter | 115 VAC, Micro Motion Model # |
| | | 9712, Micro Motion, Inc., Boulder, |
| | | Co. |
| 46 | Mix discharge pump and motor | Toshiba 20 HP 30A, Frame 215TC |
| 50 | Compressor | RDL Electrical Engineering, San |
| | | Antonio, Texas |
| 56,58 | CPU, control panel | 2 door Nema 12 Control Panel. Allen- |
| | | Bradley SLC500 PLC con. |
| 57A, | Drivers, display | Allen-Bradley Panel View 900 |
| 57B,58 | | |

The CPU is the heart of the operating system. It receives signals from flow meter (32) and scales (14A to 14D) which indicate the rate at which asphalt and crumb rubber is being to added to the mixing chamber (15). By periodically scanning these signals the CPU can adjust the speed of asphalt pump (30) and rotary vane rotor (18) to maintain a constant ratio of asphalt and rubber being added to the mixing chamber (15).

The blending process is controlled by a computerized system consisting of Allen Bradley controls and variable frequency drive motors. The blender operator enters batch size, per cent rubber to be added, per cent asphalt to be added, and how fast the batch is to be made (typically in tons per hour) into the PLC. The blending process is then started. Two main components of the computer operated system are the variable frequency drive motors that control the asphalt pump and the rotary vane feeder for the crumb rubber. The computer of CPU (56) looks at the analog inputs and the mass flow meter (for the asphalt delivery) and the load cells (for the crumb rubber). These analog inputs tell the computer the flow rate of raw materials that are being introduced into the mixing chamber. The computer can scan the signal periodically (typically every five seconds) and, through the use of the variable frequency drive motors, then speed up or slow down the asphalt cement motor to achieve the proper blend ratios.

A computer program (100) is recorded on any of a number of computer readable media, and includes program elements as illustrated in the flow chart of FIG. 2. The computer program (100) controls the mechanical devices for mixing asphalt components, and producing asphalt with desired ratios of the asphalt components. The computer program (100) begins with a batch configuration step (102). This is an optional step that is designed to gather the data necessary to start a production of asphalt. The parameters of prior production may be saved and used for the current batch if desired. If parameters are necessary or desired, the user enters the desired amount of asphalt mix components (the amount may be entered in various ways such as by ratio, percentage, weight, and mass, and in various units), as well as air blast intervals, and the final desired amount of asphalt to be produced. Generally, the ratio of asphalt mix components will be entered in tons per hour, and the final amount will be in tons. However, any units that provide the necessary information to the program (100), such that control of the ratio may be maintained, can be used. The asphalt components may be, as described above, oil and crumb rubber. Therefore, for this step (102), the user would, typically, enter the desired amounts of oil and crumb rubber.

The program (100) may cause the pre-fill (104) of the mixing chamber (15). This step (104) is designed to sequence motor start-ups to prevent generator overload then pre-fill the mixing chamber (15). Once the motors are sequenced, oil is delivered into the mixing chamber (15) until the pre-fill weight is met.

After pre-fill (104), blending begins as shown in step (106). During this step (106) the asphalt components, typically oil and crumb rubber, are mixed and blended together at desired, or pre-configured, amounts or ratios to produce asphalt. This task is accomplished by delivering the asphalt components at rates determined to provide the desired amounts. During the blending step (106), periodic checks are performed as shown in step (110). The mass flow meter (32), continuously monitors the amount of oil deposited into the mixing chamber (15) and the hopper scales (14A through D) periodically measure the weight of crumb rubber that has been deposited into the mixing chamber. With this information, the actual amounts of oil and crumb rubber that have been deposited into the mixing chamber (15) may be determined and compared against the preset desired amounts, and the rates at which the asphalt components, oil and rubber, are being delivered may be altered to achieve the desired blend ratio. Errors in the comparison step (110) may be reduced by employing a digital interface between the various measurement devices and the CPU, which helps to reduce analog/digital conversion errors.

Also during the blending step (106), a periodic air blast step (112) may be initiated. Air may be injected into the lower section of the hopper through manifold (54) at predetermined intervals to keep the crumb rubber from compacting.

Also during the blending step (106), a termination condition step (108) is periodically initiated. This step (108) causes the exiting of the blending step (106) if preset conditions are met. Generally, the amount of asphalt produced is compared to the desired amount of asphalt to be produced originally entered by the user, and if the amounts are substantially equal, then the program (100) terminates to asphalt production process. Additionally, other circumstances may terminate the asphalt production process, such as an error being found in the system, or a manual override being initiated.

### BRIEF DESCRIPTION OF THE DRAWINGS

FIG. 1 is a perspective view of the portable plant for mixing asphalt oil and crumb rubber.

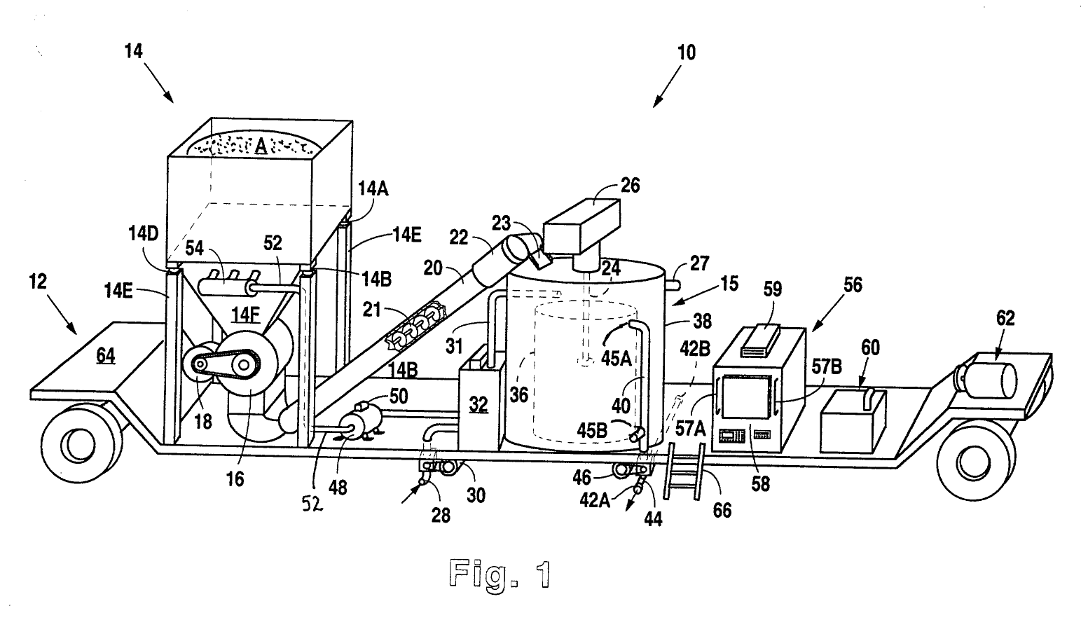

FIG. 2 is a block diagram illustrating elements of the computer program and flow chart format.

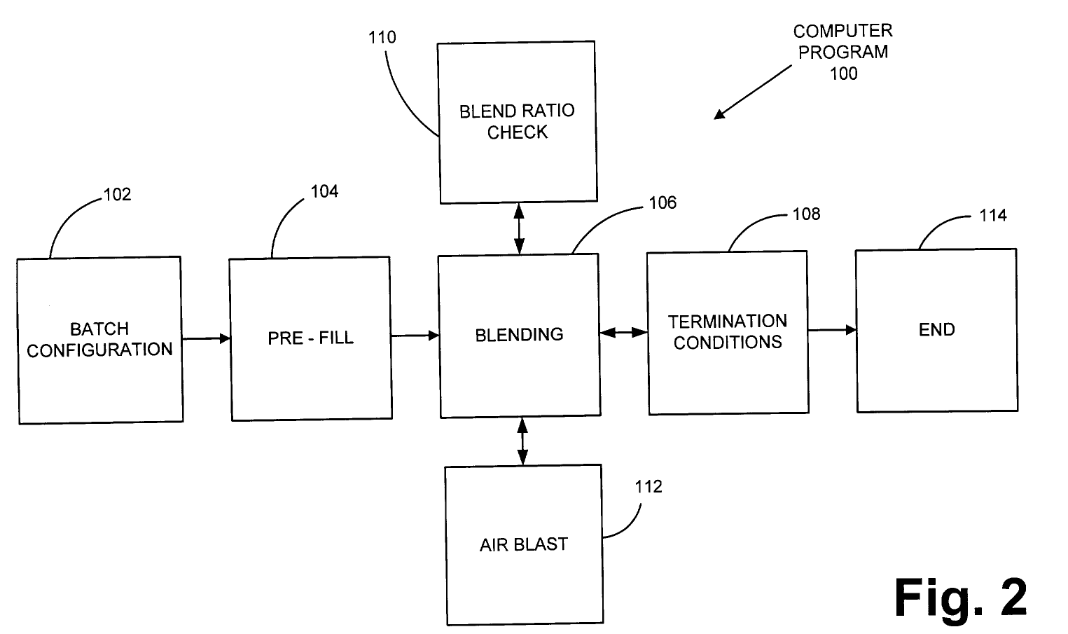

I claim:

1. A portable plant for mixing asphalt and crumb rubber, the asphalt supplied off plant from an asphalt supply source the plant comprising:
a hopper for holding the crumb rubber;
a mixing chamber for mixing the asphalt and the crumb rubber;
a crumb rubber delivery system for delivering the crumb rubber from the hopper to the mixing chamber;
a variable speed crumb rubber delivery system motor for operating the rate at which the crumb delivery system supplies the crumb rubber to the mixing chamber;
a hopper scale in operative engagement with the hopper for weighing the crumb rubber in the hopper and providing a signal;
an asphalt delivery system for delivering the asphalt from the asphalt supply source to the mixing chamber;
a variable speed asphalt pump motor for operating the rate at which the asphalt delivery system supplies the asphalt to the mixing chamber;
a mass flow meter in cooperation with the asphalt delivery system, for monitoring a flow rate of the asphalt and providing an output;
a central processing unit in operative engagement with the crumb rubber delivery system motor, the asphalt pump motor, the hopper scale, and the mass flow meter, the central processing unit containing instructions for controlling the production of an asphalt/rubber mix at a desirable asphalt to crumb rubber ratio, wherein the central processing unit:
reads the desirable ratio of asphalt to crumb rubber in the asphalt/rubber mix;
periodically calculates an actual asphalt to crumb rubber ratio deposited into the mixing chamber;
periodically compares the actual asphalt to crumb rubber ratio to the desirable asphalt to crumb rubber ratio;
directs the crumb rubber delivery system motor to speed up or slow down and the asphalt pump motor to speed up or slow down, as necessary to change the actual asphalt to crumb rubber ratio to the desirable asphalt to crumb rubber ratio; and
a wheeled trailer for mounting the hopper, the mixing chamber, the crumb rubber delivery system, the variable speed, crumb rubber delivery system motor, the asphalt delivery tube, the mass flow meter and the central processing unit thereto.

2. The portable plant of claim 1 for the comprising a wheeled trailer for mounting the hopper, the mixing chamber, the crumb rubber delivery system, the variable speed, crumb rubber delivery system motor, the asphalt delivery tube, the mass flow meter and the control means thereto.

3. The portable plant of claim 1 further including a generator, mounted to the wheeled trailer for generating electricity.

4. The portable plant of claim 1 further comprising an air compressor, mounted to the wheeled trailer, engaged with the hopper to periodically blast compressed air into the hopper to help prevent the crumb rubber from compacting.

5. The portable plant of claim 1 further including scales and operative association with the hopper, the scales to determine the weight of the crumb rubber in the hopper, said scales and operative engagement with said control means.

6. The portable plant of claim 1 further including a mixing chamber motor and mixing auger, engaged with the mixing chamber, for mixing the asphalt and crumb rubber, the motor in operative engagement with the central processing unit wherein the central processing unit controls the starting and stopping of the mixing chamber motor.

7. A computer program product stored on a computer readable medium for performing device control for use in a asphalt mixing device where a user sets a desired blend ratio of asphalt components to produce asphalt, said program product comprising program code elements for performing the functions of:
receiving said desired blend ratio of asphalt components;
periodically measuring a current actual blend ratio of asphalt components;
periodically comparing said current actual blend ratio of asphalt components to said desired blend ratio of asphalt components; and
as a result of said comparing step, causing said asphalt mixing device to add one or more of said asphalt components in a ratio such that the resulting produced asphalt has essentially said desired blend ratio of asphalt components.

8. The computer program product of claim 7, where said user sets a desired amount of asphalt to be produced, said program product further performing the functions of:
receiving said desired amount of asphalt to be produced;
periodically measuring a current actual amount of asphalt produced;
periodically comparing said current actual amount of asphalt produced to said desired amount of asphalt to be produced; and
as a result of said comparing step, causing said asphalt mixing device to terminate production of said asphalt when said current actual amount of asphalt produced is essentially equal to said desired amount of asphalt to be produced.

9. A method of operating a portable plant for mixing oil and crumb rubber in a mixing chamber, for asphalt production which produces an actual amount of asphalt, said method comprising operating computing apparatus to automatically perform the steps of:
reading an input desired amount of said asphalt to be produced, a desirable ratio of said oil and said crumb rubber to be mixed into said asphalt to create an oil/rubber mixture that is mixed producing said asphalt;
initiating filling of said mixing chamber with said input ratio of oil and said input ratio of crumb rubber;
substantially continuously monitoring the amount of said oil deposited into said mixing chamber;
periodically measuring the weight of said crumb rubber that has been deposited into said mixing chamber;
periodically calculating an actual ratio of oil deposited into said mixing chamber and original crumb rubber deposited into said mixing chamber;
periodically comparing said actual ratio of said oil against said desirable ratio of said oil, and comparing said actual ratio of said crumb rubber against said desirable ratio of said crumb rubber;
periodically initiating refilling of said mixing chamber with said oil with an amount equal to that amount necessary to make said actual ratio of oil equal to said desirable ratio of oil;
periodically initiating refilling of said mixing chamber with said crumb rubber with an amount equal to that amount necessary to make said actual ratio of crumb rubber equal to said desirable ratio of crumb rubber;
substantially continuously measuring said actual amount of asphalt produced and comparing said actual amount of asphalt to said desired amount of asphalt; and
terminating said production of asphalt when said actual amount of asphalt produced is substantially equal to said desired amount of asphalt.

10. An article of manufacture comprising:
a computer readable medium having computer readable program code means embodied thereon for causing control of a device for mixing and production of asphalt, the computer readable program code means in said article of manufacture comprising:
computer readable program code means for causing a computer to read an input desired amount of said asphalt to be produced, a desired amount of said oil to be mixed into said asphalt, and a desired amount of said crumb rubber to create an oil/rubber mixture that is mixed producing said asphalt;
computer readable program code means for causing said computer to initiate filling of said mixing chamber with said desired amount of oil and said desired amount of crumb rubber;
computer readable program code means for causing said computer to substantially continuously monitor an actual amount of said oil deposited into said mixing chamber;
computer readable program code means for causing said computer to periodically measure an actual amount of said crumb rubber that has been deposited into said mixing chamber;
computer readable program code means for causing said computer to periodically compare said desired amount of said oil against said actual amount of said oil deposited into said mixing chamber;
computer readable program code means for causing said computer to periodically compare said desired amount of said crumb rubber against said actual amount of said crumb rubber deposited into said mixing chamber;
computer readable program code means for causing said computer to periodically initiate refilling of said mixing chamber with said oil with an amount equal to that amount necessary to make said actual amount of oil deposited into said mixing chamber substantially equal to said desirable ratio of oil; and
computer readable program code means for causing said computer to periodically initiate refilling of said mixing chamber with said crumb rubber with an amount equal to that amount necessary to make said actual amount of crumb rubber deposited into said mixing chamber substantially equal to said desirable ratio of crumb rubber.

11. The article of manufacture of claim 10, further comprising:
computer readable program code means for causing said computer to substantially continuously measure said actual amount of asphalt produced and comparing said actual amount of asphalt to said desired amount of asphalt; and
computer readable program code means for causing said computer to terminate said production when said actual amount of asphalt produced is substantially equal to said desired amount of asphalt.

12. The portable plant of claim 2 wherein control means include operating computing apparatus to automatically perform the steps of:
reading an input desired amount of said asphalt rubber to be produced, a desirable ratio of said asphalt and said crumb rubber to be mixed into said asphalt rubber to create an asphalt rubber mixture that is mixed producing said asphalt;
initiating filling of said mixing chamber with said input ratio of asphalt and said input ratio of crumb rubber;
substantially continuously monitoring the amount of said asphalt deposited into said mixing chamber;
periodically measuring the weight of said crumb rubber that has been deposited into said mixing chamber;
periodically calculating an actual ratio of asphalt deposited into said mixing chamber and original crumb rubber deposited into said mixing chamber;
periodically comparing said actual ratio of said asphalt against said desirable ratio of said asphalt, and comparing said actual ratio of said crumb rubber against said desirable ratio of said crumb rubber;
periodically initiating refilling of said mixing chamber with said asphalt with an amount equal to that amount necessary to make said actual ratio of oil equal to said desirable ratio of asphalt;
periodically initiating refilling of said mixing chamber with said crumb rubber with an amount equal to that amount necessary to make said actual ratio of crumb rubber equal to said desirable ratio of crumb rubber;
substantially continuously measuring said actual amount of asphalt rubber produced and comparing said actual amount of asphalt rubber to said desired amount of asphalt rubber; and
terminating said production of asphalt rubber when said actual amount of asphalt rubber produced is substantially equal to said desired amount of asphalt rubber.

13. The portable plant of claim 1 wherein the controlled means includes:
a computer readable medium having computer readable program code means embodied thereon for causing control of a device for mixing and production of asphalt rubber, the computer readable program code means:
computer readable program code means for causing a computer to read an input desired amount of said asphalt rubber to be produced, a desired amount of said asphalt to be mixed into said asphalt rubber, and a desired amount of said crumb rubber to create an asphalt rubber that is mixed producing said asphalt;
computer readable program code means for causing said computer to initiate filling of said mixing chamber with said desired amount of asphalt and said desired amount of crumb rubber;
computer readable program code means for causing said computer to substantially continuously monitor an actual amount of said asphalt deposited into said mixing chamber;
computer readable program code means for causing said computer to periodically measure an actual amount of said crumb rubber that has been deposited into said mixing chamber;
computer readable program code means for causing said computer to periodically compare said desired amount of said asphalt against said actual amount of said asphalt deposited into said mixing chamber;
computer readable program code means for causing said computer to periodically compare said desired amount of said crumb rubber against said actual amount of said crumb rubber deposited into said mixing chamber;
computer readable program code means for causing said computer to periodically initiate refilling of said mixing chamber with said asphalt with an amount equal to that amount necessary to make said actual amount of asphalt deposited into said mixing chamber substantially equal to said desirable ratio of asphalt; and
computer readable program code means for causing said computer to periodically initiate refilling of said mixing chamber with said crumb rubber with an amount equal to that amount necessary to make said actual amount of crumb rubber deposited into said mixing chamber substantially equal to said desirable ratio of crumb rubber.

14. The portable plant of claim 13, further comprising:
computer readable program code means for causing said computer to substantially continuously measure said actual amount of asphalt rubber produced and comparing said actual amount of asphalt rubber to said desired amount of asphalt rubber; and
computer readable program code means for causing said computer to terminate said production when said actual amount of asphalt rubber produced is substantially equal to said desired amount of asphalt rubber.

15. The portable plant of claim 1 wherein the central processing unit further:
initiates the filling of the mixing chamber with the asphalt and the crumb rubber at the desirable asphalt to crumb rubber ratio.

16. The portable plant of claim 1 wherein the central processing unit further:
reads the hopper scale signal in order to monitor the amount of the crumb rubber deposited into the mixing chamber; and
reads the mass flow meter output in order to monitor the amount of the asphalt deposited into the mixing chamber.

17. The portable plant of claim 1 wherein the central processing unit further:
reads a desired amount of the asphalt/rubber mix to be produced;
calculates the actual amount of asphalt/rubber mix produced;
compares the actual amount of asphalt/rubber mix produced to the desired amount of asphalt/rubber mix; and
terminates the production of asphalt/rubber mix when the actual amount of asphalt/rubber mix produced is substantially equal to the desired amount of asphalt/rubber mix.

18. A controller for controlling the rate at which an asphalt pump motor deposits asphalt into a mixing chamber and controlling the rate at which a crumb rubber delivery system motor deposits crumb rubber into the mixing chamber, so as to maintain a desirable asphalt/rubber ratio in the asphalt/rubber mix, said controller comprising:
a central processing unit containing instructions for control, wherein the central processing unit:
monitors the amount of the crumb rubber deposited into the mixing chamber;
monitors the amount of the asphalt deposited into the mixing chamber;
periodically calculates an actual asphalt to crumb rubber ratio deposited into the mixing chamber;
periodically compares the actual asphalt to crumb rubber ratio to the desirable asphalt to crumb rubber ratio; and
directs the crumb rubber delivery system motor to speed up or slow down and the asphalt pump motor to speed up or slow down, as necessary to change the actual asphalt to crumb rubber ratio to the desirable asphalt to crumb rubber ratio.

19. The controller of claim 19 wherein the central processing unit further:
reads the desirable ratio of asphalt to crumb rubber in the asphalt/rubber mix;
initiates the filling of the mixing chamber with the asphalt and the crumb rubber at the desirable asphalt to crumb rubber ratio;

20. The controller of claim 19 wherein the central processing unit further:
reads a desired amount of the asphalt/rubber mix to be produced;
substantially continuously calculates an actual amount of asphalt/rubber mix produced and compares the actual amount of asphalt/rubber mix produced to the desired amount of asphalt/rubber mix; and
terminates the production of asphalt/rubber mix when the actual amount of asphalt/rubber mix produced is substantially equal to the desired amount of asphalt/rubber mix.

21. A portable plant for mixing asphalt and crumb rubber, the asphalt supplied off plant from an asphalt supply source the plant comprising:
a hopper for holding the crumb rubber;
a mixing chamber for mixing the asphalt and the crumb rubber;
a crumb rubber delivery system for delivering the crumb rubber from the hopper to the mixing chamber;
a variable speed crumb rubber delivery system motor for operating the rate at which the crumb delivery system supplies the crumb rubber to the mixing chamber;
a hopper scale in operative engagement with the hopper for weighing the crumb rubber in the hopper and providing a signal;
an asphalt delivery system for delivering the asphalt from the asphalt supply source to the mixing chamber;
a variable speed asphalt pump motor for operating the rate at which the asphalt delivery system supplies the asphalt to the mixing chamber;
a mass flow meter in cooperation with the asphalt delivery system for monitoring a flow rate of the asphalt and providing an output;
a central processing unit in operative engagement with the crumb rubber delivery system motor, the asphalt pump motor, the hopper scale, and the mass flow meter, the central processing unit containing instructions for controlling the production of an asphalt/rubber mix at a desirable asphalt to crumb rubber ratio, wherein the central processing unit:
reads a desired amount of the asphalt/rubber mix to be produced, and the desirable ratio of asphalt to crumb rubber in the asphalt/rubber mix;
initiates the filling of the mixing chamber with the asphalt and the crumb rubber at the desirable asphalt to crumb rubber ratio;
reads the hopper scale signal in order to monitor the amount of the crumb rubber that has been deposited into the mixing chamber;
reads the mass flow meter output in order to monitor the amount of the asphalt deposited into the mixing chamber;
periodically calculates an actual asphalt to crumb rubber ratio deposited into the mixing chamber;
periodically compares the actual asphalt to crumb rubber ratio to the desirable asphalt to crumb rubber ratio;
directs the crumb rubber delivery system motor to speed up or slow down and the asphalt pump motor to speed up or slow down, as necessary to change the actual asphalt to crumb rubber ratio to the desirable asphalt to crumb rubber ratio;
substantially continuously calculates the actual amount of asphalt/rubber mix produced and compares the actual amount of asphalt/rubber mix produced to the desired amount of asphalt/rubber mix; and
terminates the production of asphalt/rubber mix when the actual amount of asphalt/rubber mix produced is substantially equal to the desired amount of asphalt/rubber mix; and
a wheeled trailer for mounting the hopper, the mixing chamber, the crumb rubber delivery system, the variable speed, crumb rubber delivery system motor, the asphalt delivery tube, the mass flow meter and the central processing unit thereto.
